(19) United States
(12) Patent Application Publication
(10) Pub. No.: US 2009/0168271 A1
(43) Pub. Date: Jul. 2, 2009

(54) DUAL-LAYER FREE LAYER IN A TUNNELING MAGNETORESISTANCE (TMR) ELEMENT HAVING DIFFERENT MAGNETIC THICKNESSES

(76) Inventors: Daniele Mauri, San Jose, CA (US); Satoshi Shigematsu, Yokohama (JP); Alexander M. Zeltser, San Jose, CA (US)

Correspondence Address: DUFT BORNSEN & FISHMAN, LLP, 1526 SPRUCE STREET, SUITE 302, BOULDER, CO, 80302, US

(21) Appl. No.: 11/965,564

(22) Filed: Dec. 27, 2007

(51) Int. Cl. G11B 5/33

(52) U.S. Cl. 360/324.12

(57) ABSTRACT

Tunneling magnetoresistive (TMR) elements and associated methods of fabrication are disclosed. In one embodiment, the TMR element includes a ferromagnetic pinned layer structure, a tunnel barrier layer, and a free layer structure comprised of dual-layers. The free layer structure includes a first free layer and a second amorphous free layer. The magnetic thicknesses of the first free layer and the second amorphous free layer of the dual layer structure differ to provide improved TMR performance. In one example, the first free layer may have a magnetic thickness that is less than 40% of the total magnetic thickness of the free layer structure.

### RELATED APPLICATIONS

This patent application claims relates to another U.S. patent application having the Ser. No. 11/536,891 and filed on Sep. 29, 2006.

### BACKGROUND OF THE INVENTION

1. Field of the Invention

The invention is related to the field of magnetoresistance (MR) elements and, in particular, to tunneling magnetoresistance (TMR) elements having a free layer formed from dual ferromagnetic layers having different magnetic thicknesses.

2. Statement of the Problem

Many computer systems use magnetic disk drives for mass storage of information. Magnetic disk drives typically include one or more recording heads (sometimes referred to as sliders) that include read elements and write elements. An actuator/suspension arm holds the recording head above a magnetic disk. When the magnetic disk rotates, an air flow generated by the rotation of the magnetic disk causes an air bearing surface (ABS) side of the recording head to ride a particular height above the magnetic disk. The height depends on the shape of the ABS. As the recording head rides on the air bearing, an actuator moves the actuator/suspension arm to position the read element and the write element over selected tracks of the magnetic disk.

To read data from the magnetic disk, transitions on a track of the magnetic disk create magnetic fields. As the read element passes over the transitions, the magnetic fields of the transitions modulate the resistance of the read element. The change in resistance of the read element is detected by passing a sense current through the read element, and then measuring the change in bias voltage across the read element. The resulting read back signal is used to recover the data encoded on the track of the magnetic disk.

The most common type of read elements are magnetoresistance (MR) read elements. One type of MR read element is a Giant MR (GMR) element. GMR elements having two layers of ferromagnetic material (e.g., CoFe) separated by a nonmagnetic spacer layer (e.g., Cu) are generally referred to as spin valve (SV) elements. A simple-pinned SV read element generally includes an antiferromagnetic (AFM) pinning layer (e.g., PtMn), a ferromagnetic pinned layer (e.g., CoFe), a nonmagnetic spacer layer (e.g., Cu), and a ferromagnetic free layer (e.g., CoFe). The pinned layer has its magnetization fixed by exchange coupling with the AFM pinning layer. The AFM pinning layer generally fixes the magnetic moment of the pinned layer perpendicular to the ABS of the recording head. The magnetization of the free layer is not fixed and is free to rotate in response to an external magnetic field from the magnetic disk.

Another type of SV read element is an antiparallel (AP) pinned SV read element. The AP-pinned SV read element differs from the simple pinned SV read element in that an AP-pinned structure has multiple thin film layers forming the pinned layer structure instead of a single pinned layer. The pinned layer structure includes a first ferromagnetic pinned (keeper) layer (e.g., CoFe), a nonmagnetic spacer layer (e.g., Ru), and a second ferromagnetic pinned (reference) layer (e.g., CoFe). The first pinned (keeper) layer has a magnetization oriented in a first direction perpendicular to the ABS by exchange coupling with the AFM pinning layer. The second pinned (reference) layer is antiparallel coupled with the first pinned (keeper) layer across the spacer layer. Accordingly, the magnetization of the second pinned (reference) layer is oriented in a second direction that is antiparallel to the direction of the magnetization of the first pinned (keeper) layer.

Another type of MR read element is a Tunneling MR (TMR) element. TMR elements differ from GMR elements in that a thin, electrically insulating, tunnel barrier layer (e.g., aluminum oxide or magnesium oxide) is used between the pinned layer and the free layer instead of a nonmagnetic spacer layer (e.g., Cu). The TMR elements may be simple pinned or AP-pinned as with the GMR elements.

The composition and configuration of the free layer of TMR elements may vary depending on desired implementations. For instance, the free layer in one type of TMR element may include a single layer of material having a polycrystalline structure, such as CoFe or NiFe. The free layer in another type of TMR element may include a single layer of material having an amorphous structure, such as CoFeB or CoFeNiB. The free layer in another type of TMR element may include a multilayer structure comprised of polycrystalline materials (e.g., CoFe/NiFe/CoFe).

One problem with designing TMR read elements is that it is desirable to have high TMR (or TMR values) and low RA (resistance times area product) while maintaining controlled magnetostriction and coercivity. Achieving high TMR results in a TMR element having higher sensitivity, which is important for high density recording. A negative magnetostriction combined with typical prevailing mechanical stresses at the ABS helps to stabilize the free layer's magnetization parallel to the ABS, which is desirable for stable operation. While a small and negative magnetostriction is thus beneficial, an excessively large and negative magnetostriction should be avoided because it would over-stabilize the free layer and reduce its sensitivity.

A positive magnetostriction combined with the ABS mechanical stress generates a torque which tends to rotate the free layer magnetization in a direction perpendicular to the ABS. This could magnetically destabilize the sensor if the magnetostriction were sufficiently large and positive. For this reason, a positive magnetostriction should be kept small. Therefore, in general the absolute value of magnetostriction should be small for optimal operation. In the case of CoFe or CoFeB, which are commonly used in the free layer of present TMR elements, higher Fe content generally increases TMR but also increases magnetostriction.

A free layer comprised of a pure amorphous material has been shown to have large TMR coefficient but less than ideal magnetic properties. When looking for alternative free layers, one may consider that conventional free layers used in GMR elements comprise two sub-layers of CoFe and NiFe. The CoFe is employed to enhance the MR effect whereas the NiFe is added to improve the magnetic quality and control magnetostriction of the combined free layer. The same CoFe/NiFe free layer may be employed in the TMR stack but at a substantial loss of TMR. Another alternative is a pure CoFe free layer that can also deliver large TMR values but has the same shortcomings of the pure amorphous CoFeB free layer, namely poor magnetic properties.

It is thus a problem to fabricate TMR elements that have high TMR along with good magnetic properties.

### SUMMARY OF THE SOLUTION

Embodiments of the invention solve the above and other related problems with an improved TMR element having a free layer with a dual-layer structure that allows for high TMR. The TMR element includes a ferromagnetic pinned layer structure, a tunnel barrier layer, and a free layer structure formed from dual-layers. The dual-layer free layer structure includes a first ferromagnetic free layer and a second ferromagnetic amorphous free layer. The magnetic thicknesses of the first free layer and the second free layer differ to provide the improved performance. In one example, the first free layer may have a magnetic thickness that is less than 40% of the combined magnetic thickness of the free layer structure. This thickness definition allows for high TMR with controlled magnetostriction and coercivity. Also, the first free layer and the second free layer each have a composition optimized for TMR. The first free layer may be optimized for TMR by having an atomic percentage of Fe in the range of 10 to 80% (and having an atomic percentage of B in the range of 12 to 22% if it is amorphous). The second free layer may be optimized for TMR by having an atomic percentage of Fe in the range of 8 to 25% and an atomic percentage of B in the range of 8 to 20%. Optimizing TMR in the TMR elements advantageously allows the TMR to have higher sensitivity when sensing magnetic transitions, such as on a magnetic recording disk.

The invention may include other exemplary embodiments described below. For instance, other exemplary embodiments comprise methods of fabricating TMR elements described herein.

### DESCRIPTION OF THE DRAWINGS

The same reference number represents the same element or same type of element on all drawings.

FIG. 1 illustrates a TMR element in an exemplary embodiment of the invention.

FIG. 2 illustrates a free layer structure in an exemplary embodiment of the invention.

FIG. 3 is a graph illustrating the TMR values of a TMR element over different percentage magnetic thicknesses of a first free layer in an exemplary embodiment of the invention.

FIG. 4 is a graph illustrating the magnetostriction (λ) of a TMR element over different percentage magnetic thicknesses of a first free layer in an exemplary embodiment of the invention.

FIG. 5 is a graph illustrating the coercivity (Hc) of a TMR element over different percentage magnetic thicknesses of a first free layer in an exemplary embodiment of the invention.

FIG. 6 is a graph illustrating the TMR values of a TMR element over different atomic percentages of Fe in a second free layer in an exemplary embodiment of the invention.

FIG. 7 is a graph illustrating the magnetostriction (λ) of a TMR element over different atomic percentages of Fe in a second free layer in an exemplary embodiment of the invention.

FIG. 8 is a graph illustrating the coercivity (Hc) of a TMR element over different atomic percentages of Fe in a second free layer in an exemplary embodiment of the invention.

FIG. 9 is a graph illustrating the TMR values of a TMR element over different atomic percentages of B in a second free layer in an exemplary embodiment of the invention.

FIG. 10 is a graph illustrating the magnetostriction (λ) of a TMR element over different atomic percentages of B in a second free layer in an exemplary embodiment of the invention.

FIG. 11 is a graph illustrating the coercivity (Hc) of a TMR element over different atomic percentages of B in a second free layer in an exemplary embodiment of the invention.

FIG. 12 illustrates a more detailed TMR element in another exemplary embodiment of the invention.

FIG. 13 illustrates another detailed TMR element in another exemplary embodiment of the invention.

FIG. 14 illustrates another detailed TMR element in another exemplary embodiment of the invention.

FIG. 15 is a flow chart illustrating a method of fabricating a TMR element in an exemplary embodiment of the invention.

FIG. 16 illustrates a magnetic disk drive system in an exemplary embodiment of the invention.

### DETAILED DESCRIPTION OF THE INVENTION

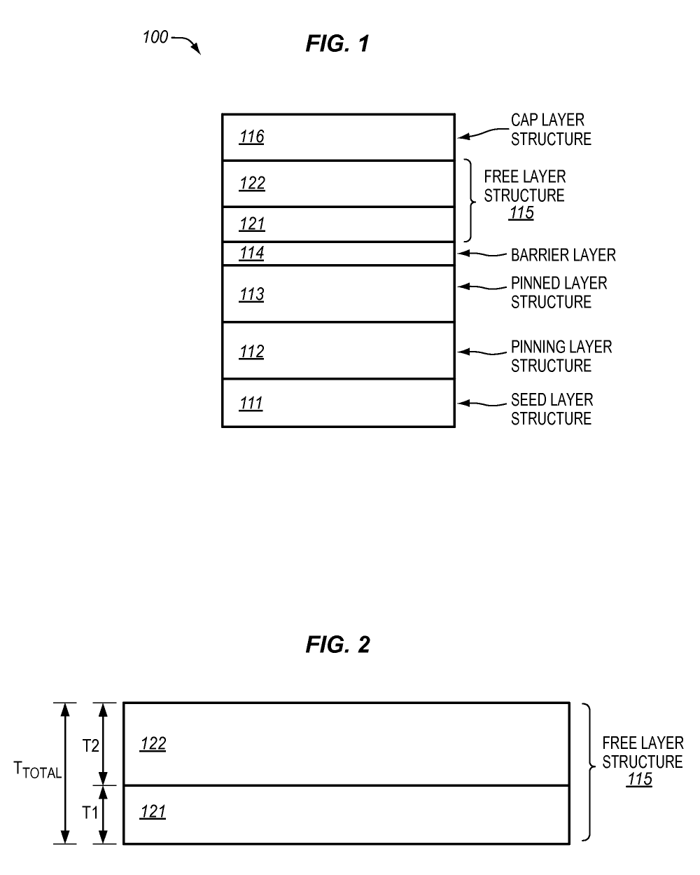

FIGS. 1-16 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents. TMR Elements

FIG. 1 illustrates a TMR element 100 in an exemplary embodiment of the invention. FIG. 1 is a view from the air bearing surface (ABS) of TMR element 100, meaning that the ABS is the surface of the page of FIG. 1. TMR element 100 includes a seed layer structure 111, a pinning layer structure 112, a ferromagnetic pinned layer structure 113, a tunnel barrier layer 114, a free layer structure 115, and a cap layer structure 116. Seed layer structure 111 comprises any layer or multi-layer structure that helps control or define the grain size of layers that are deposited on top of it. One example of seed layer structure 111 comprises a first layer of Ta, a second layer of NiFeCr, and a third layer of NiFe.

Pinning layer structure 112 comprises any layer or multi-layer structure adapted to pin the magnetization of pinned layer structure 113, such as an antiferromagnetic (AFM) layer. One example of pinning layer structure 112 comprises a layer of IrMnCr. Pinned layer structure 113 comprises any layer or multi-layer structure adapted to have its magnetization pinned in order to act as a reference layer for free layer structure 115. Pinned layer structure 113 may be a simple pinned structure or an AP-pinned structure. Pinned layer structure 113 may be formed from polycrystalline materials such as CoFe, or may be formed from amorphous materials such as CoFeB.

Barrier layer 114 comprises any non-magnetic, non-conductive layer, such as aluminum oxide or magnesium oxide. Free layer structure 115 comprises any dual-layer structure having a magnetization that is free to rotate in the presence of external magnetic fields. Cap layer structure 116 comprises any layer or multi-layer structure adapted to protect the other layers from further processing steps.

According to this embodiment, free layer structure 115 is comprised of a first ferromagnetic free layer 121 and a second ferromagnetic free layer 122. FIG. 2 illustrates free layer structure 115 in an exemplary embodiment of the invention. The first free layer 121 may be formed from polycrystalline materials such as CoFe, or may be formed from amorphous materials such as CoFeB. The second free layer 122 is formed from amorphous materials, such as CoFeB. When referred to as “amorphous”, the free layers 121-122 are amorphous as formed or deposited. When amorphous materials are grown on polycrystalline materials, the amorphous materials can tale on a polycrystalline structure on the surface touching the polycrystalline material after being deposited or annealed, all of which is within the scope of the invention.

The dual free layers 121-122 provide improved performance over prior TMR elements that implement either a single free layer or implement a multilayer free layer structure using polycrystalline or amorphous materials. The magnetic thicknesses and compositions of free layer 121 and free layer 122 differ to provide the improved performance.

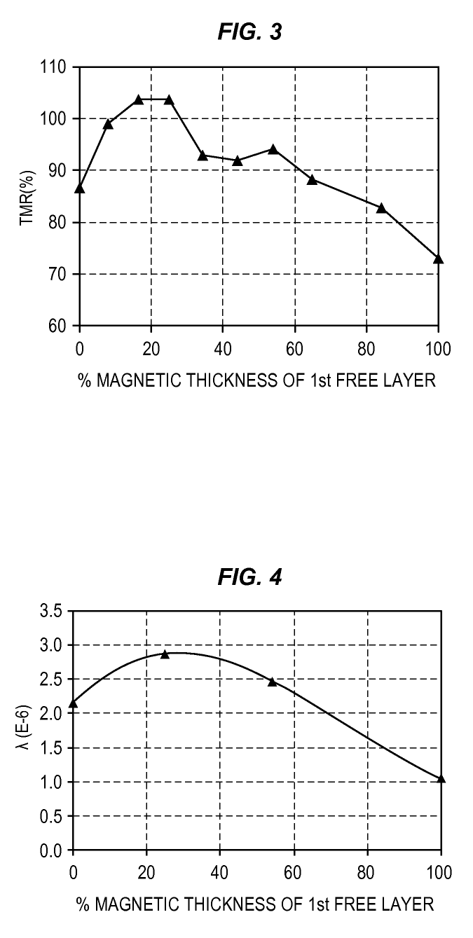

In this embodiment, the first free layer 121 has a reduced magnetic thickness compared to the second free layer 122. Magnetic thickness is defined as the equivalent thickness of an NiFe (permalloy) film with magnetostriction of about 700 emu/cm³. In FIG. 2, a magnetic thickness (T1) of the first free layer 121 and a magnetic thickness (T2) of the second free layer 122 are illustrated. The magnetic thickness (T2) of the second free layer 122 is greater than the magnetic thickness (T1) of the first free layer 121. Another way of describing the magnetic thickness of the first free layer 121 is as a percentage of the total magnetic thickness (Tₜₒₜₐₗ) of free layer structure 115 (T1/Tₜₒₜₐₗ). FIG. 3 is a graph illustrating the TMR values of TMR element 100 over different percentage magnetic thicknesses of the first free layer 121 (e.g., T1/Tₜₒₜₐₗ) in an exemplary embodiment of the invention. When the percentage magnetic thickness of the first free layer 121 is less than about 40%, the TMR values of TMR element 100 are the highest. More particularly, when the percentage magnetic thickness of the first free layer 121 is in the range of about 5% to about 40%, the TMR values of TMR element 100 are the highest. Some exemplary magnetic thicknesses achieving high TMR values include the first free layer 121 having a magnetic thickness of about 9 Å and the free layer structure 115 having a total magnetic thickness of about 46 Å. In another example, the first free layer 121 has a magnetic thickness of about 12 Å and the free layer structure 115 has a total magnetic thickness of about 45 Å.

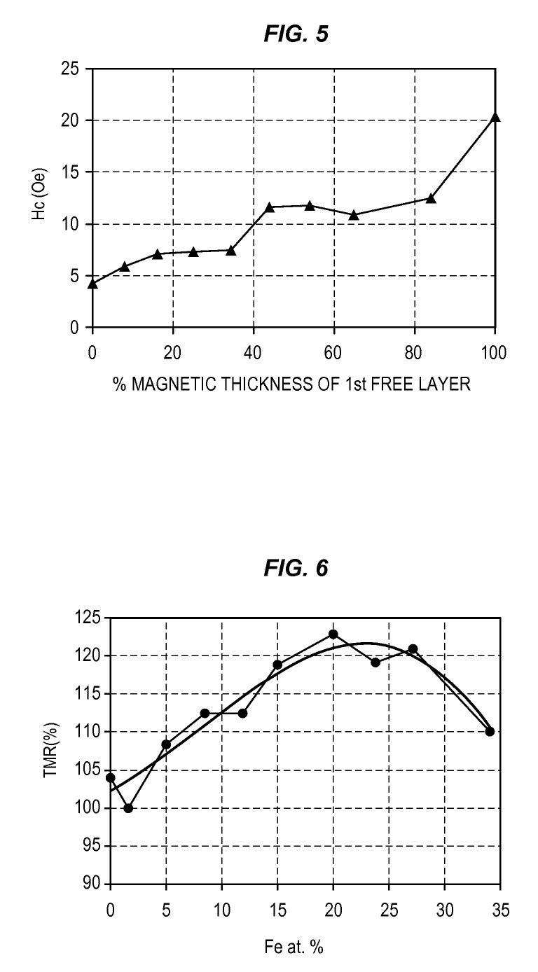

FIG. 4 is a graph illustrating the magnetostriction (λ) of TMR element 100 over different percentage magnetic thicknesses of the first free layer 121 in an exemplary embodiment of the invention. In the same percentage magnetic thickness range discussed above (5-40%), the magnetostriction is below about 3.0×10⁻⁶ which is an acceptable level. FIG. 5 is a graph illustrating the coercivity (Hc) of TMR element 100 over different percentage magnetic thicknesses of the first free layer 121 in an exemplary embodiment of the invention. In the same percentage thickness range discussed above (5-40%), the coercivity is in the range of 5 to 9 Oe which is an acceptable level.

Thus, TMR element fabricators can achieve high TMR values by controlling the magnetic thickness of the first free layer 115 as compared to the overall magnetic thickness of free layer structure 115. While achieving these high TMR values, other magnetic properties, such as magnetostriction and coercivity remain at acceptable levels.

A further way of achieving high TMR values is to control or adjust the compositions of the first free layer 121 and the second free layer 122. The first free layer 121 may have a composition optimized for TMR while the second free layer 122 may also have a composition optimized for TMR. As will be shown below, the first fi-ee layer 121 generally has a higher composition of Fe as compared to the second free layer 122.

Assume for this discussion that the second free layer 122 is an amorphous layer comprised of CoFeB. The atomic percentage of Fe in the second free layer 122 may be adjusted to achieve higher TMR values. FIG. 6 is a graph illustrating the TMR values of TMR element 100 over different atomic percentages of Fe in the second free layer 122 in an exemplary embodiment of the invention. When the atomic percentage of Fe is in the range of about 8 to about 25%, the TMR values of TMR element 100 are high (e.g., about 110%).

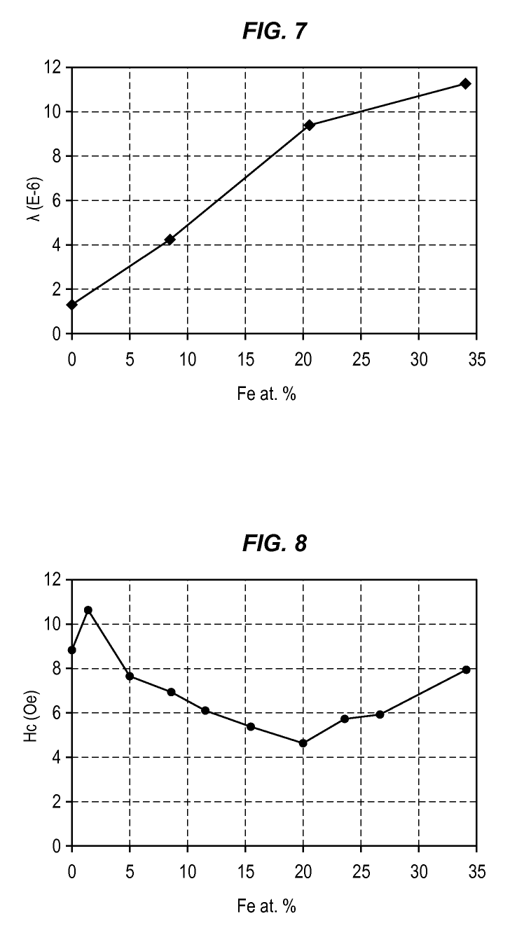

FIG. 7 is a graph illustrating the magnetostriction (λ) of TMR element 100 over different atomic percentages of Fe in the second free layer 122 in an exemplary embodiment of the invention. In the same Fe atomic percentage range discussed above (8-25%), the magnetostriction is below about 10.0×10⁻⁶ which is an acceptable level. FIG. 8 is a graph illustrating the coercivity (Hc) of TMR element 100 over different atomic percentages of Fe in the second free layer 122 in an exemplary embodiment of the invention. In the same Fe atomic percentage range discussed above (8-25%), the coercivity is less than 8 Oe, which is an acceptable level.

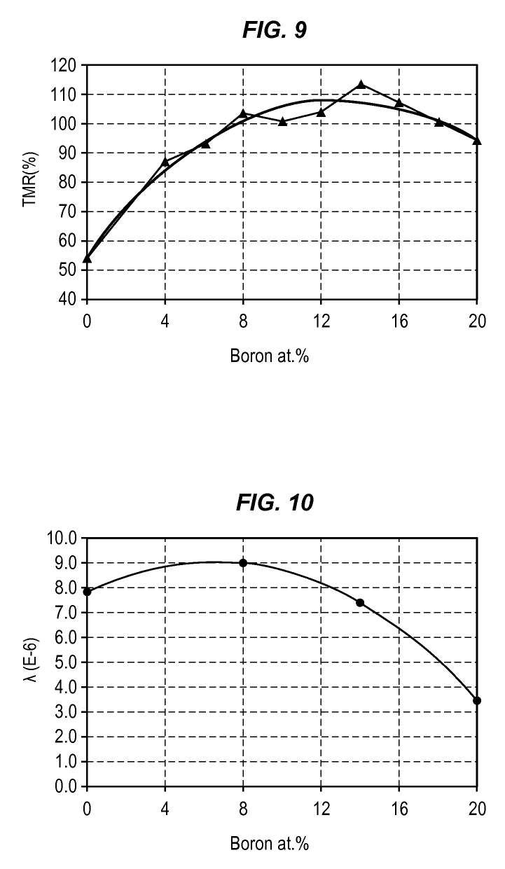

In a similar manner, the atomic percentage of B in the second free layer 122 may be adjusted in addition to or instead of adjusting the atomic percentage of Fe. FIG. 9 is a graph illustrating the TMR values of TMR element 100 over different atomic percentages of B in the second free layer 122 in an exemplary embodiment of the invention. When the atomic percentage of B is in the range of about 8 to about 20%, the TMR values of TMR element 100 are high (e.g., about 100%).

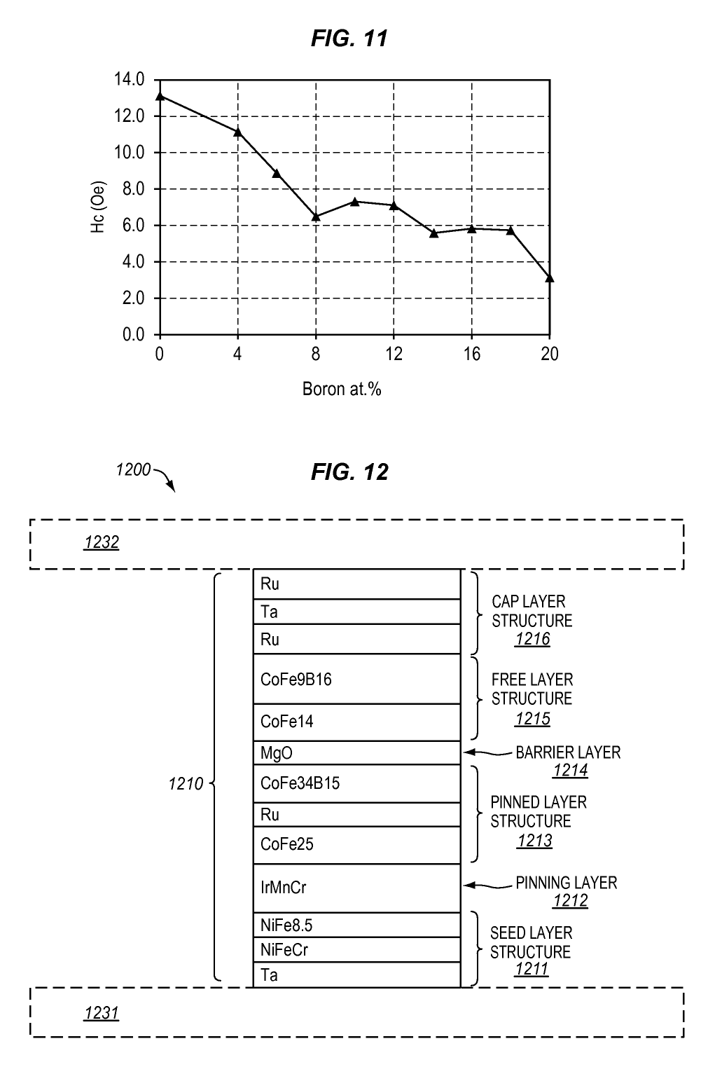

FIG. 10 is a graph illustrating the magnetostriction (λ) of TMR element 100 over different atomic percentages of B in the second free layer 122 in an exemplary embodiment of the invention. In the same B atomic percentage range discussed above (8-20%), the magnetostriction is below about 9.0×10⁻⁶ which is an acceptable level. FIG. 11 is a graph illustrating the coercivity (Hc) of TMR element 100 over different atomic percentages of B in the second free layer 122 in an exemplary embodiment of the invention. In the same B atomic percentage range discussed above (8-20%), the coercivity is less than 8 Oe, which is an acceptable level.

The composition of the first free layer 121 may also be optimized for TMR. Assume for one example that the first free layer 121 is a polycrystalline layer comprised of CoFe. The atomic percentage of Fe in the first free layer 121 may be adjusted to achieve higher TMR values. When the atomic percentage of Fe is in the range of about 10 to about 80%, the TMR values of TMR element 100 are high. Assume for another example that the first free layer 121 is an amorphous layer comprised of CoFeB. The atomic percentage of Fe and B in the first free layer 121 may be adjusted to achieve higher TMR values. When the atomic percentage of B is in the range of about 12 to 22%, the TMR values of TMR element 100 are high.

FIG. 12 illustrates a more detailed TMR element 1200 in another exemplary embodiment of the invention. FIG. 12 is a view from the ABS of TMR element 1200. TMR element 1200 is a detailed embodiment that is in no way intended to limit the scope of the invention, as exemplary layers of TMR element 1200 are shown. Those skilled in the art understand that TMR element 1200 may include other layers in other exemplary embodiments.

In FIG. 12, TMR element 1200 includes a TMR sensor 1210 sandwiched between a first shield 1231 and a second shield 1232. The first shield 1231 and the second shield 1232 may be formed from NiFe or a similar material. TMR sensor 1210 includes a seed layer structure 1211. Seed layer structure 1211 is formed from a first layer of Ta, a second layer of NiFeCr, and a third layer of NiFe8.5. Other types of seed layers may be used for seed layer structure 1211. TMR sensor 1210 further includes a pinning layer 1212. Pinning layer 1212 is formed from a layer of IrMnCr or IrMni, but other AFM materials may be used to form this layer. TMR sensor 1210 further includes a pinned layer structure 1213. Pinned layer structure 1213 comprises an antiparallel (AP) structure in this embodiment. Pinned layer structure 1213 is formed from a first layer of CoFe25, a second layer of Ru, aid a third layer of CoFe34B15. Other types of pinned layers may be used for pinned layer structure 1213.

TMR sensor 1210 further includes a barrier layer 1214. Barrier layer 1214 is formed from magnesium oxide. TMR sensor 1210 further includes a free layer structure 1215. Free layer structure 1215 is a dual-layer structure formed from a first layer of CoFe14, and a second layer of CoFe9B16. For free layer structure 1215, the first layer of CoFe14 has approximately a 9 Å magnetic thickness while the second layer of CoFe9B16 has approximately a 37 Å magnetic thickness (for a total magnetic thickness of about 46 Å). TMR sensor 1210 further includes a cap layer structure 1216. Cap layer structure 1216 is formed from a first layer of Ru, a second layer of Ta, and a third layer of Ru.

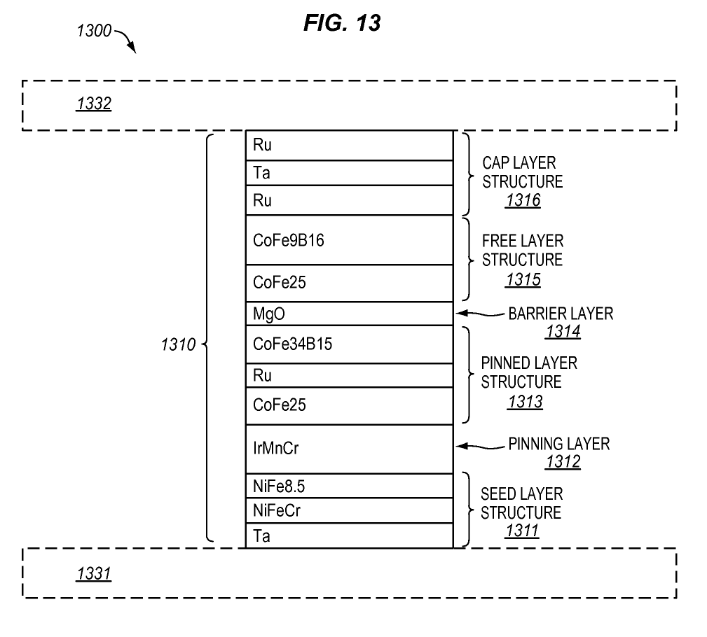

FIG. 13 illustrates a TMR element 1300 in another exemplary embodiment of the invention. FIG. 13 is a view from the ABS of TMR element 1300. TMR element 1300 is a detailed embodiment that is in no way intended to limit the scope of the invention, as exemplary layers of TMR element 1300 are shown. Those skilled in the art understand that TMR element 1300 may include other layers in other exemplary embodiments.

Much like the embodiment shown in FIG. 12, TMR element 1300 includes a TMR sensor 1310 sandwiched between a first shield 1331 and a second shield 1332. TMR sensor 1310 includes a seed layer structure 1311, a pinning layer 1312, a pinned layer structure 1313, a barrier layer 1314, a free layer structure 1315, and a cap layer structure 1316. The layers of TMR sensor 1310 are substantially similar to the layers of TMR sensor 1210 in FIG. 12, except that free layer structure 1315 has different compositions. Free layer structure 1315 includes a first layer of CoFe25 and a second layer of CoFe9B16. Again, the first layer of CoFe25 has approximately a 9 Å magnetic thickness while the second layer of CoFe9B16 has approximately a 37 Å magnetic thickness (for a total magnetic thickness of about 46 Å).

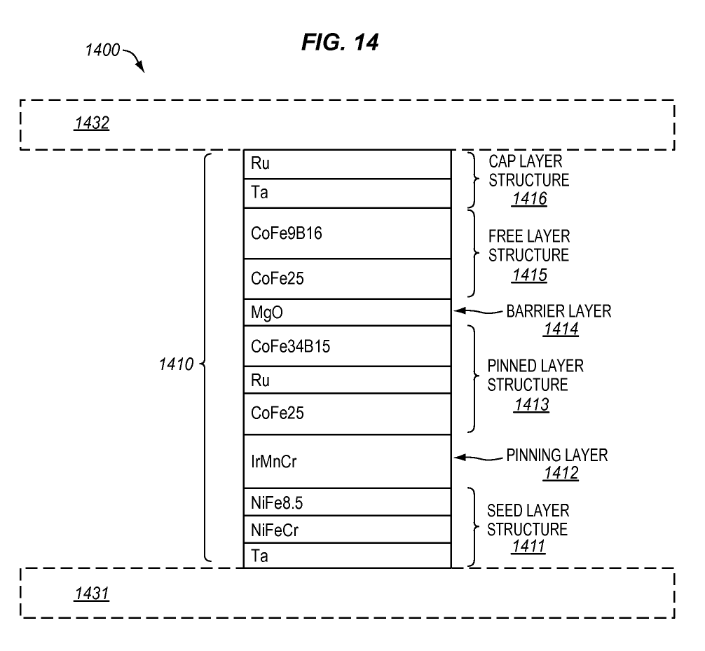

FIG. 14 illustrates a TMR element 1400 in another exemplary embodiment of the invention. FIG. 14 is a view from the ABS of TMR element 1400. TMR element 1400 is a detailed embodiment that is in no way intended to limit the scope of the invention, as exemplary layers of TMR element 1400 are shown. Those skilled in the art understand that TMR element 1400 may include other layers in other exemplary embodiments.

Much like the embodiment shown in FIGS. 12-13, TMR element 1400 includes a TMR sensor 1410 sandwiched between a first shield 1431 and a second shield 1432. TMR sensor 1410 includes a seed layer structure 1411, a pinning layer 1412, a pinned layer structure 1413, a barrier layer 1414, a free layer structure 1415, and a cap layer structure 1416. The layers of TMR sensor 1410 are substantially similar to the layers of TMR sensor 1210 in FIG. 12, except that free layer structure 1415 has different magnetic thicknesses and compositions. Free layer structure 1415 includes a first layer of CoFe25 and a second layer of CoFe9B16. The first layer of CoFe25 has approximately a 12 Å magnetic thickness, while the second layer of CoFe9B16 has approximately a 33 Å magnetic thickness (for a total magnetic thickness of about 45 Å). Also, cap layer structure 1416 is different than in FIGS. 12-13. Cap layer structure 1416 is formed from a first layer of Ta and a second layer of Ru.

### Fabrication Method

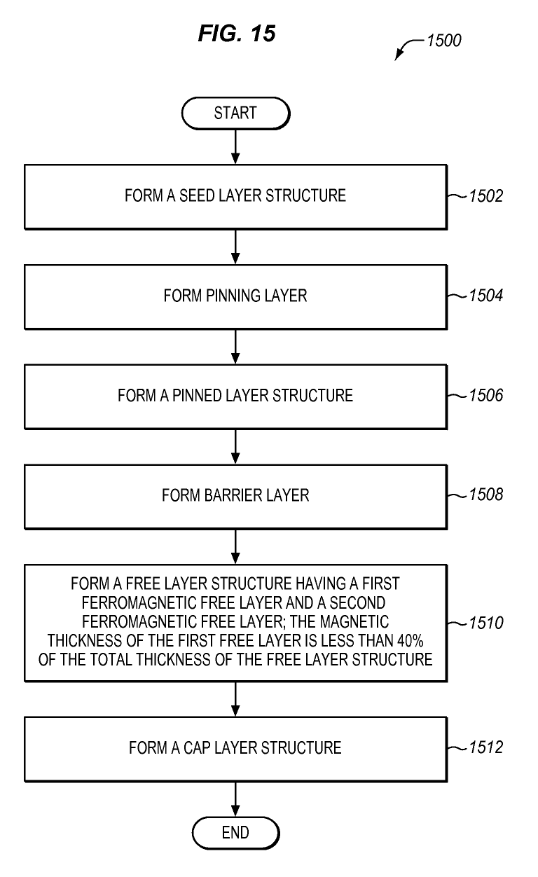

FIG. 15 is a flow chart illustrating a method 1500 of fabricating a TMR element in an exemplary embodiment of the invention. Method 1500 may be used to fabricate the TMR elements shown in FIGS. 1 and 12-14. The steps of the flow chart in FIG. 15 are not all inclusive and may include other steps not shown.

Step 1502 comprises forming a seed layer structure. The seed layer structure may be formed by depositing a first layer of Ta, depositing a second layer of NiFeCr, and depositing a third layer of NiFe8.5 as shown in FIGS. 12-14. Step 1504 comprises forming a pinning layer structure. The pinning layer structure may be formed by depositing a layer of IrMnCr as shown in FIGS. 12-14. Step 1506 comprises forming a pinned layer structure. The pinned layer structure may comprise an AP structure that is formed by depositing a first layer of CoFe25, a second layer of Ru, and a third layer of CoFe34B15 as shown in FIGS. 12-14. Step 1508 comprises forming a barrier layer. The barrier layer may be formed by depositing magnesium oxide.

Step 1510 comprises forming a free layer structure. The free layer structure comprises a dual-layer structure that is formed by a first ferromagnetic free layer and a second ferromagnetic free layer (see also FIG. 2). The first free layer may be formed from polycrystalline materials such as CoFe, or may be formed from amorphous materials such as CoFeB. The second free layer is formed with amorphous materials, such as CoFeB. The first free layer has a reduced magnetic thickness as compared to the second free layer to provide improved TMR values. To provide desired results, the magnetic thickness of the first free layer is less than 40% of the total magnetic thickness of the free layer structure. Some exemplary magnetic thicknesses achieving high TMR values include the first free layer having a magnetic thickness of about 9 Å and the free layer structure having a magnetic thickness of about 46 Å. In another example, the first free layer has a magnetic thickness of about 12 Å and the free layer structure has a magnetic thickness of about 45 Å. The first free layer and the second free layer may also have the composition ranges described in FIG. 2.

Step 1512 comprises forming a cap layer structure. The cap layer structure may be formed by depositing a first layer of Ru, depositing a second layer of Ta, and depositing a third layer of Ru as shown in FIGS. 12-13. In another embodiment, the cap layer structure may be formed by depositing a first layer of Ta and depositing a second layer of Ru as shown in FIG. 14.

### Magnetic Disk Drive System

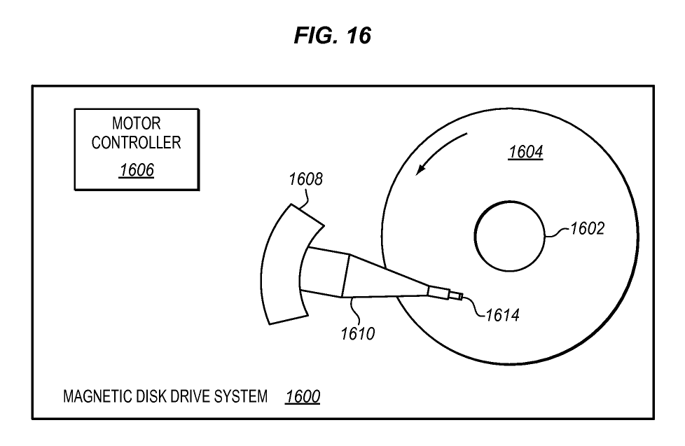

The TMR elements shown in FIGS. 1 and 12-14 may be implemented in a magnetic disk drive system, or in other magnetic applications such as memories. FIG. 16 illustrates a magnetic disk drive system 1600 in an exemplary embodiment of the invention. Magnetic disk drive system 1600 includes a spindle 1602, a magnetic recording medium 1604, a motor controller 1606, an actuator 1608, an actuator/suspension arm 1610, and a recording head 1614. Spindle 1602 supports and rotates magnetic recording medium 1604 in the direction indicated by the arrow. A spindle motor (not shown) rotates spindle 1602 according to control signals from motor controller 1606. Recording head 1614 is supported by actuator/suspension arm 1610, and actuator/suspension arm 1610 is connected to actuator 1608 that is configured to rotate in order to position recording head 1614 over a desired track of magnetic recording medium 1604. Magnetic disk drive system 1600 may include other devices, components, or systems not shown in FIG. 16. For instance, a plurality of magnetic disks, actuators, actuator/suspension arms, and recording heads may be used.

When magnetic recording medium 1604 rotates, an air flow generated by the rotation of magnetic disk 1604 causes an air bearing surface (ABS) of recording head 1614 to ride on a cushion of air at a particular height above magnetic disk 1604. The height depends on the shape of the ABS. As recording head 1614 rides on the cushion of air, actuator 1608 moves actuator/suspension arm 1610 to position a read element (not shown) and a write element (not shown) in recording head 1614 over selected tracks of magnetic recording medium 1604. The read element in recording head 1614 may comprise a TMR element as described herein in the above FIGS.

Although specific embodiments were described herein, the scope of the invention is not limited to those specific embodiments. The scope of the invention is defined by the following claims and any equivalents thereof.

We claim:

1. A tunneling magnetoresistance (TMR) element, comprising:
a ferromagnetic pinned layer structure;
a nonmagnetic barrier layer; and
a free layer structure comprised of a first ferromagnetic free layer and a second ferromagnetic amorphous free layer;
wherein a magnetic thickness of the first ferromagnetic free layer is less than 40% of the magnetic thickness of the free layer structure.

2. The TMR element of claim 1 wherein the second ferromagnetic amorphous free layer is comprised of CoFeB having an atomic percentage of Fe in the range of 8 to 25%.

3. The TMR element of claim 2 wherein the second ferromagnetic amorphous free layer has an atomic percentage of B in the range of 8 to 20%.

4. The TMR element of claim 1 wherein the first ferromagnetic free layer is comprised of CoFe having an atomic percentage of Fe in the range of 10 to 80%.

5. The TMR element of claim 1 wherein the first ferromagnetic free layer is comprised of CoFeB having an atomic percentage of Fe in the range of 10 to 80% and an atomic percentage of B in the range of 12 to 22%.

6. The TMR element of claim 1 further comprising a cap layer structure comprised of:
a first cap layer formed from Ta adjacent to the second ferromagnetic amorphous free layer; and
a second cap layer formed from Ru adjacent to the first cap layer.

7. The TMR element of claim 1 further comprising a cap layer structure comprised of:
a first cap layer formed from Ru adjacent to the second ferromagnetic amorphous free layer;
a second cap layer formed from Ta adjacent to the first cap layer; and
a third cap layer formed from Ru adjacent to the second cap layer.

8. The TMR element of claim 1 further comprising:
an antiferromagnetic (AFM) pinning layer adjacent to the ferromagnetic pinned layer structure; and
a seed layer structure between the AFM pinning layer and a shield, wherein the seed layer structure comprises one of a first layer of Ta and a second layer of Ru, or a first layer of Ta, a second layer of NiFeCr, and a third layer of NiFe.

9. The TMR element of claim 1 wherein the ferromagnetic pinned layer structure includes:
a first ferromagnetic pinned layer;
a nonmagnetic spacer layer formed from Ru adjacent to the first ferromagnetic pinned layer; and
a second ferromagnetic amorphous pinned layer adjacent to the nonmagnetic spacer layer and the nonmagnetic barrier layer.

10. A method of fabricating a tunneling magnetoresistance (TMR) element, the method comprising:
forming a ferromagnetic pinned layer structure;
forming a nonmagnetic barrier layer; and
forming a free layer structure comprised of a first ferromagnetic free layer and a second ferromagnetic amorphous free layer;
wherein a magnetic thickness of the first ferromagnetic free layer is less than 40% of the magnetic thickness of the free layer structure.

11. The method of claim 10 wherein the second ferromagnetic amorphous free layer is comprised of CoFeB having an atomic percentage of Fe in the range of 8 to 25%.

12. The method of claim 11 wherein the second ferromagnetic amorphous free layer has an atomic percentage of B in the range of 8 to 20%.

13. The method of claim 10 wherein the first ferromagnetic free layer is comprised of CoFe having an atomic percentage of Fe in the range of 10 to 80%.

14. The method of claim 10 wherein the first ferromagnetic free layer is comprised of CoFeB having an atomic percentage of Fe in the range of 10 to 80% and an atomic percentage of B in the range of 12 to 22%.

15. The method of claim 10 further comprising forming a cap layer structure by:
forming a first cap layer from Ta on the second ferromagnetic amorphous free layer; and
forming a second cap layer from Ru adjacent to the first cap layer.

16. The method of claim 10 further comprising forming a cap layer structure by:
forming a first cap layer from Ru on the second ferromagnetic amorphous free layer;
forming a second cap layer from Ta on the first cap layer; and
forming a third cap layer from Ru on the second cap layer.

17. The method of claim 10 further comprising:
forming a seed layer structure on a shield prior to forming the ferromagnetic pinned layer structure; and
forming an antiferromagnetic (AFM) pinning layer on the seed layer structure;
wherein the seed layer structure comprises one of a first layer of Ta and a second layer of Ru, or a first layer of Ta, a second layer of NiFeCr, and a third layer of NiFe.

18. The method of claim 10 wherein forming the ferromagnetic pinned layer structure comprises:
forming a first ferromagnetic pinned layer;
forming a nonmagnetic spacer layer formed from Ru on the first ferromagnetic pinned layer; and
forming a second ferromagnetic amorphous pinned layer on the nonmagnetic spacer layer.

19. A magnetic disk drive system, comprising:
a magnetic disk; and
a recording head that includes a tunneling magnetoresistance (TMR) element for reading data from the magnetic disk, the TMR element comprising:
a ferromagnetic pinned layer structure;
a nonmagnetic barrier layer; and
a free layer structure comprised of a first ferromagnetic free layer and a second ferromagnetic amorphous free layer;
wherein a magnetic thickness of the first ferromagnetic free layer is less than 40% of the magnetic thickness of the free layer structure.

20. The magnetic disk drive system of claim 19 wherein the second ferromagnetic amorphous free layer is comprised of CoFeB having an atomic percentage of Fe in the range of 8 to 25%, and has an atomic percentage of B in the range of 8 to 20%.

21. A tunneling magnetoresistance (TMR) element, comprising:
a ferromagnetic pinned layer structure;
a nonmagnetic barrier layer; and
a free layer structure comprised of a first ferromagnetic free layer and a second ferromagnetic amorphous free layer;
wherein the first ferromagnetic free layer and the second ferromagnetic amorphous free layer are optimized for TMR with the first ferromagnetic free layer comprised of a CoFe-based material having an atomic percentage of Fe in the range of 10 to 80% and the second ferromagnetic amorphous free layer comprised of CoFeB having an atomic percentage of Fe in the range of 8 to 25%.

22. The TMR element of claim 21 wherein the second ferromagnetic amorphous free layer has an atomic percentage of B in the range of 8 to 20%.

23. The TMR element of claim 21 wherein the first ferromagnetic free layer is comprised of CoFeB having an atomic percentage of B in the range of 12 to 22%.

24. A method of fabricating a tunneling magnetoresistance (TMR) element, the method comprising:
forming a ferromagnetic pinned layer structure;
forming a nonmagnetic barrier layer; and
forming a free layer structure comprised of a first ferromagnetic free layer and a second ferromagnetic amorphous free layer;
wherein the first ferromagnetic free layer and the second ferromagnetic amorphous free layer are optimized for TMR with the first ferromagnetic free layer comprised of a CoFe-based material having an atomic percentage of Fe in the range of 10 to 80% and the second ferromagnetic amorphous free layer comprised of CoFeB having an atomic percentage of Fe in the range of 8 to 25%.

25. The method of claim 24 wherein the second ferromagnetic amorphous free layer has an atomic percentage of B in the range of 8 to 20%.

26. The method of claim 24 wherein the first ferromagnetic free layer is comprised of CoFeB having an atomic percentage of B in the range of 12 to 22%.
